(19) United States
(12) Patent Application Publication
(10) Pub. No.: US 2015/0360609 A1
(43) Pub. Date: Dec. 17, 2015

(54) Vehicle Safety Alert

(71) Applicant: Roger Dwayne Allen, McLeansboro, IL (US)

(72) Inventor: Roger Dwayne Allen, McLeansboro, IL (US)

(21) Appl. No.: 14/301,481

(22) Filed: Jun. 11, 2014

(51) Int. Cl. B60Q 9/00

(52) U.S. Cl. CPC B60Q 9/008

(57) ABSTRACT

A safety alert comprises a first vehicle with a microchip, a Global Position Satellite, and a second vehicle with a GPS monitor. The microchip broadcasts a signal through the GPS to the GPS monitor, alerting the second vehicle's driver that there is a first vehicle nearby, thereby reducing the likelihood of a collision.

### CROSS REFERENCES TO RELATED APPLICATIONS

Provisional Application for Patent No. 61/956872 of Jun. 19, 2013 with the same title, “Vehicle Safety Alert” which is hereby incorporated by reference. Applicant claims priority pursuant to 35 U.S.C. Par. 119(e)(i).

A portion of the disclosure of this disclosure for this patent document contains material to which a claim for copyright is made. This copyright owner has no objection to the facsimile reproduction of by anyone of the patent document or the patent disclosure, as it appears in the Patent and Trademark Office Patent the or records, but reserves all other copyrights whatsoever.

STATEMENTS AS TO RIGHTS TO INVENTIONS MADE UNDER FEDERALLY SPONSORED RESEARCH AND DEVELOPMENT

Not applicable

### BACKGROUND OF THE INVENTION

1. Field of the Invention

This invention relates to a vehicle safety alert which, installed in a first vehicle, alerts an operator of a second vehicle that the first vehicle is nearby. It is intended primarily for, but not restricted to, motorcycles, ATVs, and emergency response vehicles such as, but not restricted to, ambulances and fire engines.

2. Background Information

Many accidents occur from vehicle operators not being aware of other vehicles in their vicinity.

Also, many motorcycle accidents occur in the blind spot of a vehicle driver making a left turn.

Also, ATVs suddenly darting across a country road too often cause accidents.

Also, there are examples of Emergency Response vehicles such as fire engines and ambulances colliding with vehicles whose drivers were unaware of the proximity of an Emergency Response vehicle.

As will be seen from the subsequent description of the preferred embodiments of the present invention, this present invention simplifies detection of nearby, often overlooked, vehicles such as, but not restricted to motorcycles, ATVs, and Emergency Response Vehicles as well as alerting other vehicle drivers there is a nearby motorcycle, ATV, ambulance, or police car.

### SUMMARY OF THE INVENTION

The preferred embodiment of the present invention is a safety alert comprising a microchip installed in a first vehicle such as, but not restricted to a motorcycle, ATV, ambulance, fire engine or police squad car, a GPS (i.e. Global Positioning System) monitoring device in a second vehicle, such as, but not restricted to, an automobile or a truck, and the use of a GPS.

The microchip in the first vehicle serves to alert the GPS monitor in the second vehicle, through the GPS that the second vehicle is within a given distance of the first vehicle with the microchip. In the preferred embodiment of the present invention, the microchip in the first vehicle sends information to the GPS monitor hi the second vehicle via the GPS, enabling a driver of the second vehicle to see where the first vehicle is with respect to the vehicle.

Microchips emitting a signal are existing technology, well known to the trade and commercially available,

Global Positioning Systems involving satellites are common.

However, the use of a microchip installed hi a first vehicle to send a signal that is receivable in a second vehicle's GPS monitor through a GPS is a creative solution to the problem of accidents resulting drivers of second vehicles being unaware of the presence of a first vehicle.

Such accidents are common as a result of second vehicle drivers not seeing a first vehicle and are not able to determine the position of the first vehicle with respect to the second vehicle.

This also applies to ATVs.

Also, when an emergency response vehicle turns on the emergency vehicle's flashing lights, power is fed to the microchip and the microchip broadcasts a signal, via the GPS to all the second vehicles' GPS devices, the drivers of the second vehicles know there is an emergency response vehicle coming.

### BRIEF DESCRIPTION OF THE DRAWING

FIG. 1 illustrates the preferred embodiment of the present invention, a vehicle safety alert.

### DESCRIPTION OF THE PREFERRED EMBODIMENTS

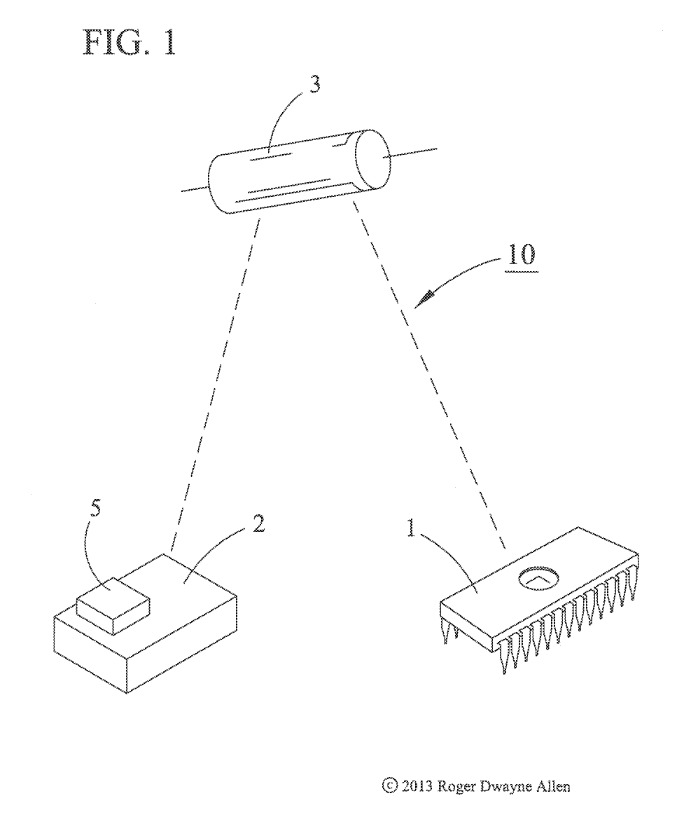

Referring to FIG. 1, the preferred embodiment of the present invention, a vehicle safety alert 10 comprises a GPS monitor 2 installed in a second vehicle (not shown) such as an automobile or a truck: a first vehicle (not shown) such as, but not restricted to a motorcycle, ATV, or emergency response vehicle such as, but not restricted to, a fire truck, an ambulance, or a police car, with a microchip 1, and a GPS 3.

The microchip 1 in the first vehicle broadcasts a signal through the GPS 3 into the GPS monitor 2 in the second vehicle.

GPS monitor 2 comprises a symbol 5, such as, but not restricted to, an icon, representing the first vehicle enabling a driver of the second vehicle to be aware that there is a first vehicle nearby and see where that first vehicle is located so as to reduce the likelihood of a tragic accident from the second vehicle colliding with the first vehicle because of the operator of the second vehicle being unaware of the presence of the first vehicle.

In the preferred embodiment of the present invention, when the first vehicle with the microchip 1 gets within a given distance, say 60 feet as an example for a motorcycle, or perhaps 2 miles for a fire truck or an ambulance, the first vehicle symbol 5 in the GPS monitor 2 would light up, alerting the second vehicle operator of the presence of the first vehicle. Also, existing technology, known in the art, can also, if desired show the location of the first vehicle with respect to the second vehicle.

Also, in the preferred embodiment of the present invention, the GPS monitor 2 emits a non-distractive audible alert.

Also, this combination of technology can be licensed to motorcycle manufacturers, dealers, and operators as well as vehicle manufacturers such as, but not limited to trucks and automobiles, as well as the manufacturers, providers, and users of GPS monitors.

The microchip 3 is also useful for tracking down stolen motorcycles.

The microchip 1 is known in the art and is commercially available, as are appropriate apps enabling the reception of the microchip 1 broadcast to the aforementioned GPS monitor 2.

Although the description above contains many specificities, these should not be construed as limiting the scope of the invention, but as merely providing illustrations of some of the preferred embodiments of the present invention.

It will be obvious to those skilled in the art that modifications may be made to the embodiments described above without departing from the scope of the present invention. Thus the scope of the invention should be determined by the appended claims in the formal application and their legal equivalents, rather than by the examples given.

1. A vehicle safety alert comprising:
a) a first vehicle with a microchip,
b) a second vehicle with a GPS monitor, and
c) a GPS,
wherein the microchip in the first vehicle broadcasts a signal through the GPS to the GPS monitor in a second vehicle,
wherein an operator of the second vehicle is alerted that the first vehicle is nearby so there is a reduced likelihood of an accident from the first and second vehicles colliding because of the operator of the second vehicle being unaware of the presence of the first vehicle.

2. The vehicle safety alert of claim 1 wherein the GPS monitor in second vehicle comprises a symbol that lights up alerting the operator of the second vehicle that there is a first vehicle nearby.

3. The vehicle safety alert of claim 2 wherein the symbol shows the location of the first vehicle with respect to the second vehicle.

4. The vehicle safety alert of claim 3 wherein the GPS monitor emits an audible alert as well as showing the location of the first vehicle with respect to the second vehicle.

5. The vehicle safety alert of claim 1 wherein the first vehicle is an emergency response vehicle with emergency lights and the microchip in the first vehicle is in electrical contact with emergency lights so that when the emergency lights are on, the microchip 1 is broadcasting the signal, through the GPS, to any second vehicles with the GPS monitor nearby so that there is a reduced likelihood of a collision.
